(19) United States
(12) Patent Application Publication
(10) Pub. No.: US 2014/0321739 A1
(43) Pub. Date: Oct. 30, 2014

(54) IMAGE PROCESSING METHOD AND APPARATUS AND ELECTRONIC DEVICE

(71) Applicant: Sony Corporation, Tokyo (JP)

(72) Inventor: Redfar Yang, Beijing (CN)

(73) Assignee: Sony Corporation, Tokyo (JP)

(21) Appl. No.: 14/351,610

(22) PCT Filed: Dec. 26, 2013
(86) PCT No.: PCT/IB2013/061348

§ 371 Date: Apr. 14, 2014

(30) Foreign Application Priority Data
Apr. 26, 2013 (CN) 201310150367.7

(51) Int. Cl. G06T 5/00; G06T 11/00; G06T 11/60

(52) U.S. Cl. CPC G06T 5/002; G06T 11/60; G06T 11/001
USPC 382/162; 382/284

(57) ABSTRACT

The embodiments of the present invention provide an image processing method and apparatus and electronic device. The image processing method includes: acquiring a visible image and an infrared image of a captured object; decomposing the visible image to generate a base image layer containing low frequency components; decomposing the infrared image to generate a detail image layer containing high frequency components; and combining the base image layer and the detail image layer, so as to generate a combined image of the captured object. In the embodiments of the present invention, a combined image with the surface of a captured object being smooth and important characteristic portions being kept without distortion can be obtained.

### CROSS-REFERENCE TO RELATED APPLICATION AND PRIORITY CLAIM

This application claims priority from Chinese patent application No. 201310150367.7, filed Apr. 26, 2013, the entire disclosure of which hereby is incorporated by reference.

### TECHNICAL FIELD

The present invention relates to image processing technologies, and in particular to an image processing method and apparatus and electronic device.

### BACKGROUND ART

Portraiture is one of the most important aspects of photograph for all digital cameras. But moles, freckles, wrinkles and hair will cause pigmentation irregularities, thereby reducing their appeal. Therefore, smoothing processing is needed to be performed on the portraiture captured by the digital cameras, so as to remove or attenuate the pigmentation irregularities in the portraiture, and at the same time, high frequency details of the images need to be saved.

### SUMMARY OF THE INVENTION

However, it is found by the inventors that the captured images are directly processed in the prior art, wherein while the surface of the captured object is kept smooth, many characteristic portions are lost, resulting in distortion in the images. Therefore, important characteristic image information cannot be kept while performing smoothing processing on the skin.

It should be noted that the above introduction to the background art is only for clear and complete explanation of the technical solution of the present invention, and for the understanding by those skilled in the art. It should not be construed that the above technical solution is known to those skilled in the art as it is described in the background art.

The embodiments of the invention provide an image processing method and apparatus and electronic device, with an object being to obtain an image with the surface of a captured object being smooth and characteristic portions being kept without distortion.

According to one aspect of the embodiments of the invention, there is provided an image processing method, including:

acquiring a visible image and an infrared image of a captured object;

decomposing the visible image to generate a base image layer containing low frequency components;

decomposing the infrared image to generate a detail image layer containing high frequency components; and

combining the base image layer and the detail image layer, so as to generate a combined image of the captured object.

According to another aspect of the embodiments of the invention, the decomposing the visible image to generate a base image layer containing low frequency components includes:

transforming the visible image into a color image of a YCbCr space;

extracting a luminance channel image and a chrominance channel image of the color image of the YCbCr space; and

decomposing the luminance channel image to generate the base image layer.

According to still another aspect of the embodiments of the invention, the method further includes:

combining the combined image and the chrominance channel image to generate a color combined image; and

transferring the color combined image into an RGB space.

According to further still another aspect of the embodiments of the invention, the low frequency components reflect basic image information of the captured object, and the high frequency components reflect characteristic image information of the captured object.

According to further still another aspect of the embodiments of the invention, the captured object includes: a human face or skin.

According to further still another aspect of the embodiments of the invention, the base image layer reflects basic image information of the human face or skin, and the detail image layer reflects characteristic image information of the human face or skin.

According to further still another aspect of the embodiments of the invention, the range of infrared wavelength for acquiring the infrared image is 700 nm-1100 nm.

According to further still another aspect of the embodiments of the invention, the low frequency components of the visible image and/or the high frequency components of the infrared image are determined by using a wavelet decomposing algorithm.

According to further still another aspect of the embodiments of the invention, the low frequency components of the visible image and/or the high frequency components of the infrared image are filtered by using a bilateral filter algorithm, so as to generate the base image layer and/or the detail image layer.

According to further still another aspect of the embodiments of the invention, there is provided an image processing apparatus, includes:

an image acquiring unit, configured to acquire a visible image and an infrared image of a captured object;

a visible image decomposing unit, configured to decompose the visible image to generate a base image layer containing low frequency components;

an infrared image decomposing unit, configured to decompose the infrared image to generate a detail image layer containing high frequency components; and

an image combining unit, configured to combine the base image layer and the detail image layer, so as to generate a combined image of the captured object.

According to further still another aspect of the embodiments of the invention, the visible image decomposing unit includes:

a visible image transforming unit, configured to transform the visible image into a color image of a YCbCr space;

a visible image extracting unit, configured to extract a luminance channel image and a chrominance channel image of the color image of the YCbCr space; and

a luminance channel image decomposing unit, configured to decompose the luminance channel image to generate the base image layer.

According to further still another aspect of the embodiments of the invention, the image processing apparatus further includes:

a color adding unit, configured to combine the combined image and the chrominance channel image to generate a color combined image; and

an image restoring unit, configured to transfer the color combined image into an RGB space.

According to further still another aspect of the embodiments of the invention, there is provided an electronic device, includes the image processing apparatus as described above.

Advantages of embodiments of the invention include: a combined image with the surface of a captured object being smooth and important characteristic portions being kept without distortion can be obtained, by combining low frequency components of a visible image and high frequency components of an infrared image of a captured object.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a flowchart of the image processing method of Embodiment 1 of the present invention;

FIG. 2 is a graphical diagram showing comparison of absorptivity of light waves of different wavelengths by melanin and hemoglobin;

FIG. 3 is a schematic diagram showing comparison of visible images and infrared images of fleck, speckle and mole of the skin;

FIG. 4 is a flowchart of the image processing method of Embodiment 2 of the present invention;

FIG. 5 is a flowchart of image decomposition of Embodiment 2 of the present invention;

FIG. 6 is a schematic diagram showing comparison of RGB color combined image of a captured object and an original RGB color combined image of the captured object;

FIG. 7 is a schematic diagram of the structure of an image processing apparatus of Embodiment 3 of the present invention;

FIG. 8 is a schematic diagram of the structure of an image processing apparatus of Embodiment 4 of the present invention;

FIG. 9 is a schematic diagram of the structure of an visible image decomposing unit of Embodiment 4 of the present invention; and

FIG. 10 is a block diagram of the systematic composition of an electronic device of Embodiment 5 of the present invention.

### DETAILED DESCRIPTION OF THE INVENTION

Various embodiments of the present invention shall be described below with reference to the accompanying drawings. These embodiments are illustrative only, and are not intended to limit the present invention.

### Embodiment 1

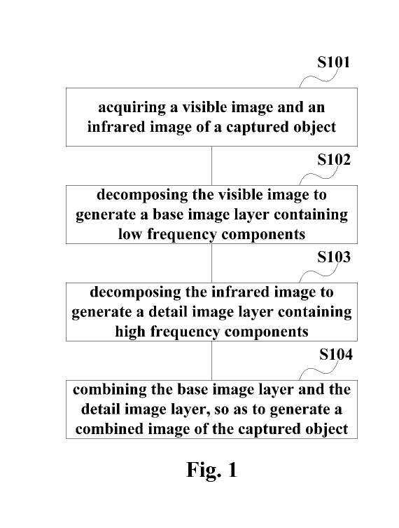

An embodiment of the present invention provides an image processing method. FIG. 1 is a flowchart of the image processing method of Embodiment 1 of the present invention. As shown in FIG. 1, the method includes:

Step S101: acquiring a visible image and an infrared image of a captured object;

Step S102: decomposing the visible image to generate a base image layer containing low frequency components;

Step S103: decomposing the infrared image to generate a detail image layer containing high frequency components; and

Step S104: combining the base image layer and the detail image layer, so as to generate a combined image of the captured object.

In this embodiment, the captured object may be a human face, or may also be skin of other parts of a human body, or may be skin of other biological objects. However, the present invention is not limited thereto. For example, it may be other objects (including biological or abiological objects). Particular objects may be determined as actually required, and the following description is given taking a human face as an example.

For example, when a human portraiture is captured, the absorptivity of melanin and hemoglobin, which affect the color of human skin, is different for rays of different bands. Hence, the images of human skin obtained in different bands reflect different skin information.

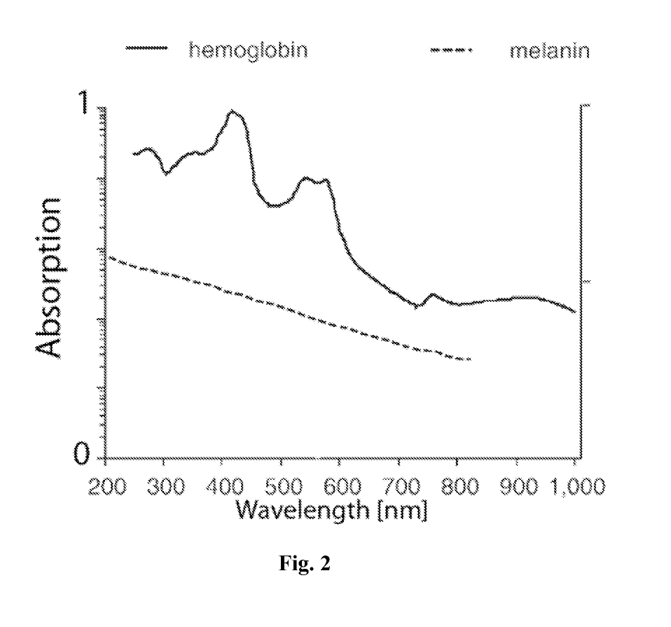

FIG. 2 is a schematic graphical diagram showing comparison of absorptivity of light waves of different wavelengths by melanin (broken lines) and hemoglobin (solid lines). It can be seen from FIG. 2 that the absorptivity of hemoglobin and melanin for an infrared light (for example, in a range of wavelength of 700 nm-1100 nm) is lower than that for a visible light. Therefore, as the wavelength of the infrared light is relatively long, the infrared light is less absorbed and scattered by the skin, thereby penetrating deeper into the skin layers.

As the infrared light has higher penetrability, an infrared image of the skin contains less skin surface information than a visible image.

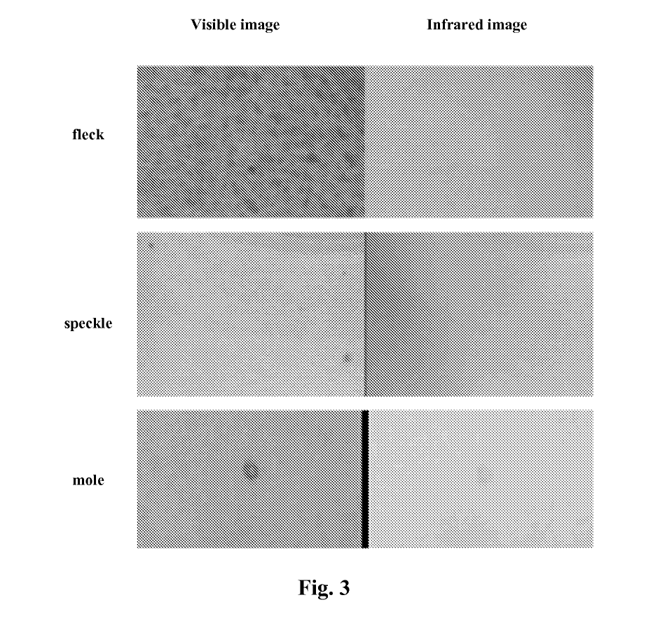

FIG. 3 is a schematic diagram showing comparison of visible images and infrared images of fleck, speckle and mole of the skin. It can be seen from FIG. 3 that the fleck, speckle and mole in the infrared image are more shallow than those in the visible image; that is, the infrared image contains less skin surface information.

This embodiment of the present invention is based on the principle that the absorptivity of skin for visible light and infrared light is different and hence the visible image and infrared image reflect different skin surface information. It should be noted that the above exemplary explanation is given taking human skin as an example. However, the present invention is not limited thereto. For example, the method or apparatus of the present invention is also applicable to other captured objects if they have different absorptivity for visible light and infrared light.

In step S101 of this embodiment, those skilled in the art may obtain a visible image and an infrared image of a captured object in many manners of the prior art. For example, an LED flash lamp of a mobile device may be used to provide supplementary lighting to the captured object needed in capturing, and a digital camera of the mobile device may be used to acquire an image of the captured object. In a capturing light path, the captured object may be photographed respectively by moving in or moving away a movable IR cut-off filter, thereby obtaining a visible image and an infrared image of the captured object; or, the captured object may be photographed respectively by switching off either sensitivity of visible channel or sensitivity of infrared channel in an image sensor, thereby also obtaining a visible image and an infrared image of the captured object. In this embodiment, the range of the wavelength of the infrared light for acquiring the infrared image may be 700 nm-1100 nm, for example.

In step S102, the visible image is decomposed to generate a base image layer containing low frequency components, the low frequency components of the image reflecting basic image information of the captured object. In particular implementation, the visible image of the skin may be decomposed into low frequency components containing low frequency information and high frequency components containing high frequency information; where, the low frequency components may reflect information including basic image information of the skin itself, such as information on the profile, and edge, etc. of the skin, and the high frequency components may reflect characteristic image information of the skin, such as information on hair, eye, and speckle of the skin.

As a visible image reflects relatively more skin surface information, and low frequency components reflect the basic image information of the skin itself, the base image layer containing the low frequency components can reflect basic image information of the skin surface, thereby saving the basic image information of the skin surface to the maximum extent.

In step S103, the infrared image is decomposed to generate a detail image layer containing high frequency components, the high frequency components reflecting characteristic image information of the captured object. In particular implementation, for an infrared image of the skin, it can also be decomposed into low frequency components containing low frequency information and high frequency components containing high frequency information. Where, the low frequency components reflect information including basic image information of the skin itself, such as information on the profile, and edge, etc. of the skin, and the high frequency components reflect characteristic image information of the skin, such as information on hair, eye, and speckle of the skin.

As an infrared image of the skin reflects relatively less skin surface information, the detail image layer of the infrared image containing the high frequency components can reflect less characteristic image information of the skin surface than the detail image layer of the visible image containing the high frequency components, such as information on speckle, etc. However, high frequency information out of the skin surface, such as information on hair, and eye, etc., may also be saved.

In step S104, the base image layer and the detail image layer are combined to generate a combined image of the captured object. In the combined image of the captured object, basic image information of the skin surface comes from the base image layer of the visible image, and characteristic image information of the skin surface comes from the detail image layer of the infrared image.

As the base image layer contains the low frequency components of the visible image, the basic image information of the skin surface can be saved to the maximum extent; thereby ensuring that the basic image information of the skin of the combined image will not be distorted. For example, the profile, and edge, etc. of the skin will not be deformed due to the image combining. As the detail image layer contains high frequency components of the infrared image, the characteristic image information of the skin surface, such as information on wrinkle, and speckle, etc., is less reflected in the combined image. Hence, an image of the captured object with smooth skin surface is obtained, while high frequency information out of the skin surface information can be saved.

It can be seen from the above embodiment that: a combined image with the surface of a captured object being smooth and important characteristic image information being kept without distortion can be obtained, by combining the low frequency components of the visible image and the high frequency components of the infrared image of the captured object.

### Embodiment 2

On the basis of Embodiment 1, an embodiment of the present invention provides an image processing method, in order to further describe the present invention, with those parts identical to Embodiment 1 being not described any further.

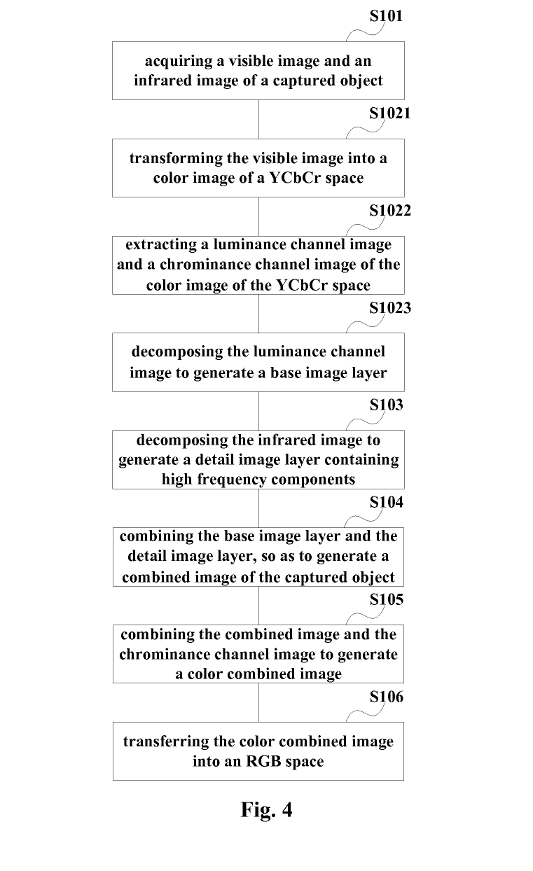

FIG. 4 is a flowchart of the image processing method of Embodiment 2 of the present invention. As shown in FIG. 4, the image processing method includes:

Step S101: acquiring a visible image and an infrared image of a captured object;

Step S1021: transforming the visible image into a color image of a YCbCr space;

Step S1022: extracting a luminance channel image and a chrominance channel image of the color image of the YCbCr space;

Step S1023: decomposing the luminance channel image to generate a base image layer;

Step S103: decomposing the infrared image to generate a detail image layer containing high frequency components; and

Step S104: combining the base image layer and the detail image layer, so as to generate a combined image of the captured object.

Where, step S101, step S103 and step S104 in Embodiment 2 are identical to those of Embodiment 1, and shall not be described herein any further. The difference between Embodiment 2 and Embodiment 1 exists in: S102 in Embodiment 1 is further decomposed into step S1021, step S1022 and step S1023.

In an existing digital camera, a charge couple device (CCD) or a complementary metal-oxide semiconductor (CMOS) device is mainly used as an imaging device, and most of the visible images formed by the CCD and CMOS are color images of the RGB space. Therefore, the present invention shall be described in this embodiment taking the YcbCr space and the RGB space as examples.

In Embodiment 2, after acquiring the visible image of the captured object in step S101, the visible image is transferred from the RGB space to the YcbCr space in step S1021, so as to generate a color image of the YcbCr space. The prior art may be referred to for the details of the YcbCr space and the RGB space.

In step S1022, the color image of the YcbCr space may be decomposed into a luminance channel (Y channel) image and a chrominance channel (Cb channel and Cr channel) image. Where, the luminance channel image contains information on the luminance of the image, and the chrominance channel image contains information on the chrominance of the image. Methods of the prior art may be used in transferring the RGB space to the YcbCr space and extracting the luminance channel image and the chrominance channel image of the color image of the YcbCr space, which shall not described herein any further.

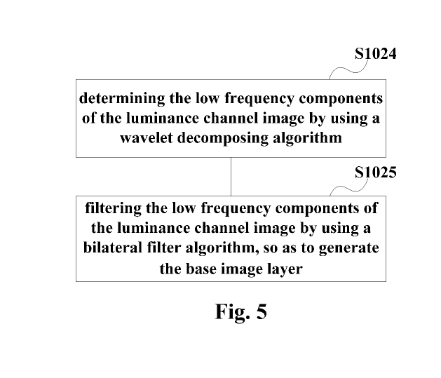

In step S1023, the luminance channel image may be decomposed to generate a base image layer. FIG. 5 is a flowchart of image decomposition. A method of image decomposition of the embodiment of the present invention shall be described below with reference to FIG. 5 taking a wavelet decomposing algorithm and a bilateral filter algorithm as examples. It should be noted that the present invention is not limited thereto, and other manners may also be used for image decomposition, such as a Matifus algorithm, etc.

As shown in FIG. 5, the method for decomposing a luminance channel image of the embodiment of the present invention includes the steps of:

Step S1024: determining the low frequency components of the luminance channel image by using a wavelet decomposing algorithm; and

Step S1025: filtering the low frequency components of the luminance channel image by using a bilateral filter algorithm, so as to generate the base image layer.

Where, the wavelet decomposing algorithm is used to decide which information in the luminance channel image is determined as high frequency components and which information is determined as low frequency components; and the bilateral filter algorithm is a commonly-used space filter algorithm where images are smoothed and boundaries are saved. After the high frequency components and the low frequency components are decided by the wavelet decomposing algorithm, the low frequency components of the luminance channel image are filtered by using the bilateral filter algorithm, thereby obtaining the base image layer containing the low frequency components. The low frequency information obtained by the wavelet decomposition, i.e. the basic information of the skin surface, is mainly saved in the base image layer.

In another embodiment of the present invention, a wavelet decomposing algorithm may also be used in step S103 to determine the high frequency components of the infrared image, and a bilateral filter algorithm may also be used to filter the high frequency components of the infrared image, thereby generating a detail image layer of the infrared image containing the high frequency components. The high frequency information of the skin obtained by the wavelet decomposition is mainly saved in the detail image layer

In still another embodiment of the present invention, after the base image layer (Y-base) obtained by using visible lights and bilateral filtering and the detail image layer (NIR-detail) obtained by using infrared lights and bilateral filtering are obtained, the base image layer and the detail image layer are combined in step S104. As the luminance information in the base image layer and the detail image layer may be directly added up and subtracted, a manner may be used in combining the base image layer and the detail image layer, where luminance values are added up directly at positions of pixels of different luminance values, and one of the luminance values is taken at positions of pixels of identical luminance values.

The base image layer of the visible light contains low frequency information under the visible light, such as basic information of the skin surface, and does not contain information on skin characteristics, such as flecks, etc.; and the detail image layer of the infrared light contains high frequency information under the infrared light, such as hair, and eye, etc. At the same time, due to extremely low reflection and absorption of the skin for the infrared light, such detail high frequency information as flecks of the skin is not presented in the detail image layer of the infrared light, therefore the image obtained by combining the base image layer of the visible light and the detail image layer of the infrared light may achieve an effect of not presenting flecks, etc.

In further still another embodiment of the present invention, as shown in FIG. 4, the method may further include steps S105 and S106; and after the combined image of the captured object is obtained, chrominance information may be added into the combined image of the captured object.

For example, in step S105, the combined image may be combined with the chrominance channel image extracted in step S1022, so as to obtain a color combined image of the YCbCr space. Then, in step S106, the color combined image of the YCbCr space is transferred back to the RGB space, so as to form a color combined image of the RGB space, for being displayed on a display screen of a digital camera, or for being stored into a memory of a color camera.

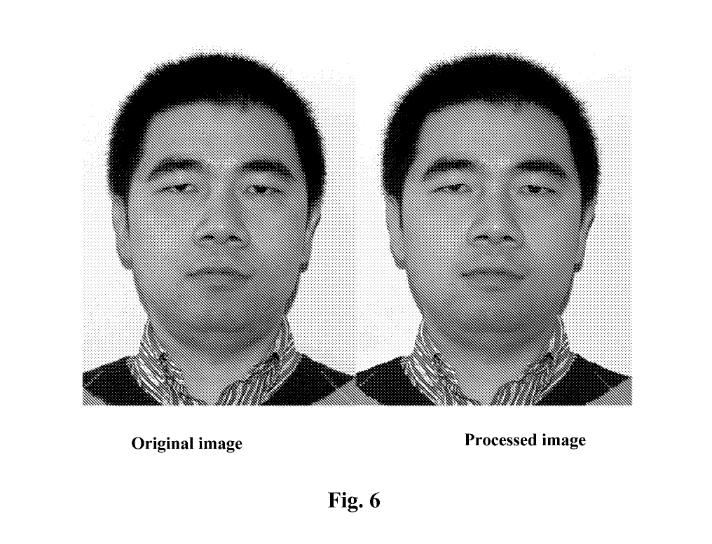

FIG. 6 is a schematic diagram showing comparison of RGB color combined image of a captured object and an original RGB color combined image of the captured object. As shown in FIG. 6, in comparison with the original image, in the image processed by using the method of the present invention, the flecks of the human skin are removed, the skin looks more smooth and soft, the profile of the skin is not deformed, and important high frequency information, such as hair, and eye, etc., is saved.

It can be seen from the above embodiment that: a combined image with the surface of a captured object being smooth and important characteristic image information being kept without distortion can be obtained, by combining the low frequency components of the visible image and the high frequency components of the infrared image of the captured object.

### Embodiment 3

An embodiment of the present invention provides an image processing apparatus, which corresponds to the image processing method of Embodiment 1, with those contents identical to Embodiment 1 being not going to be described any further.

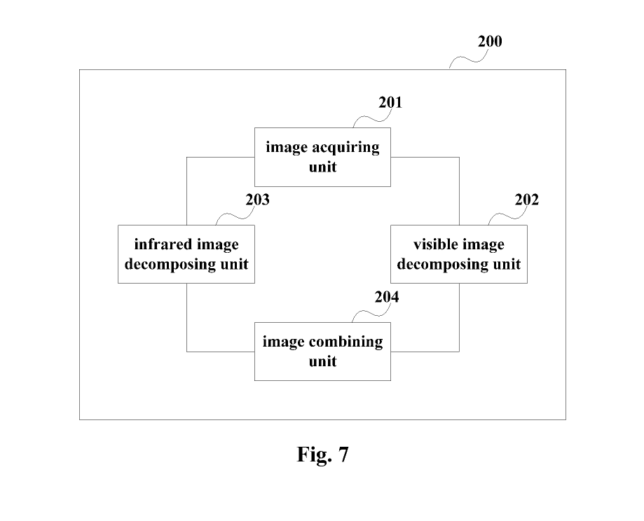

FIG. 7 is a schematic diagram of the structure of the image processing apparatus of the embodiment of the present invention. As shown in FIG. 7, the image processing apparatus 200 includes:

an image acquiring unit 201, configured to acquire a visible image and an infrared image of a captured object;

a visible image decomposing unit 202, configured to decompose the visible image to generate a base image layer containing low frequency components;

an infrared image decomposing unit 203, configured to decompose the infrared image to generate a detail image layer containing high frequency components; and

an image combining unit 204, configured to combine the base image layer and the detail image layer, so as to generate a combined image of the captured object.

Refer to the particular operating manners of the corresponding steps in embodiments 1 and 2 for the particular operating manners of the units of this embodiment, which shall not be described herein any further. It should be noted that only part of the composition of the image processing apparatus 200 related to this embodiment is shown, other parts of the image processing apparatus are not shown, for which the prior art may be referred to.

In this embodiment, the image processing apparatus 200 may be integrated into an electronic device, such as being integrated into a mobile terminal, for use with a pickup in coordination therewith. However, the present invention is not limited thereto, and particular application scenarios may be determined as actually required.

It can be seen from the above embodiment that: a combined image with the surface of a captured object being smooth and important characteristic image information being kept without distortion can be obtained, by combining the low frequency components of the visible image and the high frequency components of the infrared image of the captured object.

### Embodiment 4

On the basis of Embodiment 3, an embodiment of the present invention provides an image processing apparatus.

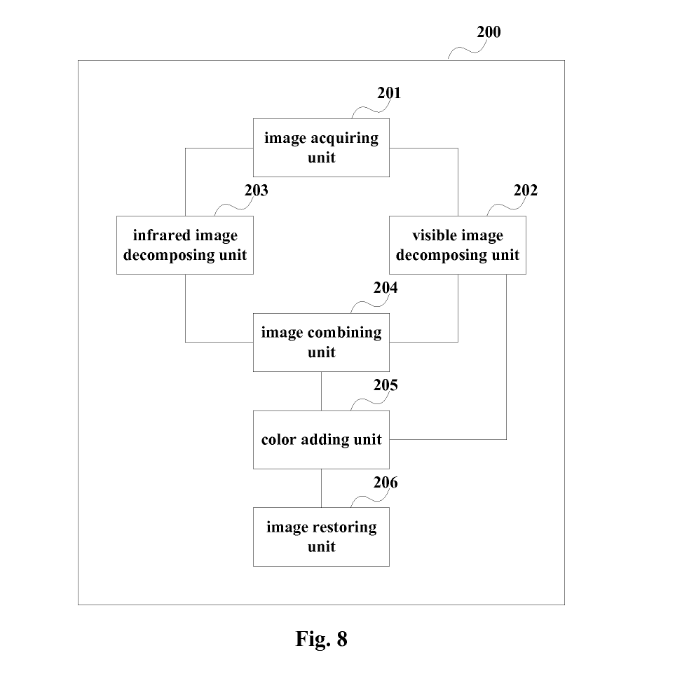

FIG. 8 is a schematic diagram of the structure of the image processing apparatus of the embodiment of the present invention. As shown in FIG. 8, the image processing apparatus 200 includes: an image acquiring unit 201, a visible image decomposing unit 202, an infrared image decomposing unit 203 and an image combining unit 204, which are identical to those of the image processing apparatus in Embodiment 3.

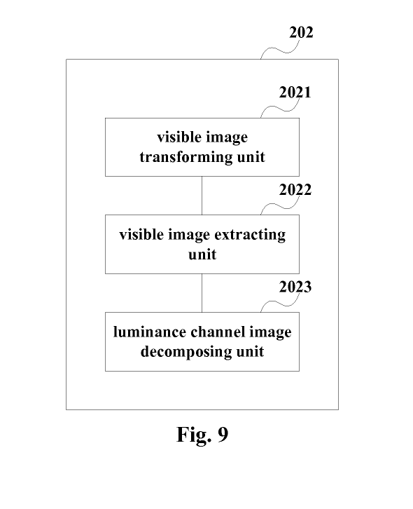

FIG. 9 is a schematic diagram of the structure of the visible image decomposing unit 202 of the embodiment of the present invention. As shown in FIG. 9, in Embodiment 4 of the present invention, the visible image decomposing unit 202 may include:

a visible image transforming unit 2021, configured to transform the visible image into a color image of a YCbCr space;

a visible image extracting unit 2022, configured to extract a luminance channel image and a chrominance channel image of the color image of the YCbCr space; and

a luminance channel image decomposing unit 2023, configured to decompose the luminance channel image to generate the base image layer.

In this embodiment, the particular operating manners of the corresponding steps in Embodiment 2 may be referred to for the particular operating manners of the parts of the visible image decomposing unit 202, which shall not be described herein any further. Furthermore, the infrared image decomposing unit 203 of this embodiment may also use a wavelet decomposing algorithm and a bilateral filter algorithm to decompose an infrared image, so as to obtain a detail image layer containing high frequency components.

As shown in FIG. 8, the image processing apparatus 200 may further include:

a color adding unit 205, configured to combine the combined image obtained by the image combining unit 204 and the chrominance channel image extracted from the visible image extracting unit 2022 to generate a color combined image; and

an image restoring unit 206, configured to transfer the color combined image to an RGB space, so as to generate a color combined image of the RGB space, for facilitating an electronic camera to display or store.

It can be seen from the above embodiment that with the image processing apparatus of the embodiment of the present invention, the generated combined image contains both low frequency information of the visible image and high frequency information of the infrared image, thereby saving basic information of the skin itself, such as high frequency information on hair, and eye, etc., while not presenting information on flecks, or the link, on the skin, or attenuating such information.

### Embodiment 5

An embodiment of the present invention provides an electronic device, including the image processing apparatus as described in Embodiment 3 or 4.

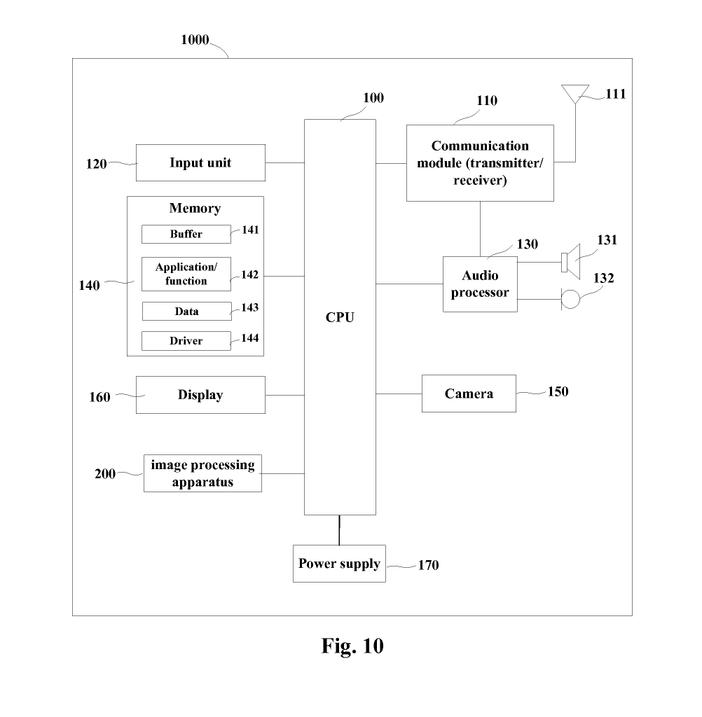

FIG. 10 is a block diagram of the systematic composition of the electronic device of the embodiment of the present invention, including the image processing apparatus 200. As shown in FIG. 10, the image processing apparatus 200 may be connected to a CPU 100. It should be noted that this figure is exemplary only, and other types of structures may be used for supplementing or replacing this structure, so as to realized telecommunications functions or other functions.

As shown in FIG. 10, the electronic device 1000 may further include a CPU 100, a communication module 110, an input unit 120, an audio processing unit 130, a memory 140, a camera 150, a display 160, and a power supply 170.

The CPU 100 (sometimes referred to as a controller or control, which may include a microprocessor or other processor devices and/or logic devices) receives input and controls every components and operations of the electronic device 1000. The input unit 120 provides input to the CPU 100. The input unit 120 is, for example, a key or a touch input device. The camera 150 is used to take image data and provide the taken image data to the CPU 100, for use in a conventional manner, such as storage, and transmission, etc.

The power supply 170 is used to supply electric power to the electronic device 1000. The display 160 is used to display the display objects, such as images, and letters, etc. The display may be, for example, an LCD display, but it is not limited thereto.

The memory 140 is coupled to the CPU 100. The memory 140 may be a solid-state memory, such as a read-only memory (ROM), a random access memory (RAM), and a SIM card, etc. It may also be such a memory that stores information when the power is interrupted, may be optionally erased and provided with more data. Examples of such a memory are sometimes referred to as an EPROM, etc. The memory 140 may also be certain other types of devices. The memory 140 includes a buffer memory 141 (sometimes referred to as a buffer). The memory 140 may include an application/function storing portion 142 used to store application programs and function programs, or to execute the flow of the operation of the electronic device 1000 via the CPU 100.

The memory 140 may further include a data storing portion 143 used to store data, such as a contact person, digital data, pictures, voices and/or any other data used by the electronic device. A driver storing portion 144 of the memory 140 may include various types of drivers of the electronic device for the communication function and/or for executing other functions (such as application of message transmission, and application of directory, etc.) of the electronic device.

The communication module 110 is a transmitter/receiver 110 transmitting and receiving signals via an antenna 111. The communication module (transmitter/receiver) 110 is coupled to the CPU 100 to provide input signals and receive output signals, this being similar to the case in a conventional mobile phone.

A plurality of communication modules 110 may be provided in the same electronic device for various communication technologies, such a cellular network module, a Bluetooth module, and/or wireless local network module, etc. The communication module (transmitter/receiver) 110 is also coupled to a loudspeaker 131 and a microphone 132 via the audio processing unit 130, for providing audio output via the loudspeaker 131 and receiving the audio input from the microphone 132, thereby achieving common telecommunications functions. The audio processing unit 130 may include any appropriate buffers, decoders, and amplifiers, etc. The audio processing unit 130 is further coupled to the central processing unit 100, thereby enabling the recording of voices in this device via the microphone 132 and playing the voices stored in this device via the loudspeaker 131.

An embodiment of the present invention further provides a computer-readable program, where when the program is executed in an electronic device, the program enables the computer to carry out the image processing method as described in Embodiment 1 or 2 in the electronic device.

An embodiment of the present invention further provides a storage medium in which a computer-readable program is stored, where the computer-readable program enables the computer to carry out the image processing method as described in Embodiment 1 or 2 in an electronic device.

The preferred embodiments of the present invention are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, where the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. An image processing method, comprising:
acquiring a visible image and an infrared image of a captured object;
decomposing the visible image to generate a base image layer containing low frequency components;
decomposing the infrared image to generate a detail image layer containing high frequency components; and
combining the base image layer and the detail image layer, so as to generate a combined image of the captured object.

2. The image processing method according to claim 1, wherein the decomposing the visible image to generate a base image layer containing low frequency components comprises:
transforming the visible image into a color image of a YCbCr space;
extracting a luminance channel image and a chrominance channel image of the color image of the YCbCr space; and
decomposing the luminance channel image to generate the base image layer.

3. The image processing method according to claim 1, wherein the method further comprises:
combining the combined image and the chrominance channel image to generate a color combined image; and
transferring the color combined image into an RGB space.

4. The image processing method according to claim 2, wherein the low frequency components reflect basic image information of the captured object, and the high frequency components reflect characteristic image information of the captured object.

5. The image processing method according to claim 3, wherein the captured object comprises: a human face or skin.

6. The image processing method according to claim 1, wherein the base image layer reflects basic image information of the human face or skin, and the detail image layer reflects characteristic image information of the human face or skin.

7. The image processing method according to claim 1, wherein the range of infrared wavelength for acquiring the infrared image is 700 nm-1100 nm.

8. The image processing method according to claim 1, wherein the low frequency components of the visible image and/or the high frequency components of the infrared image are determined by using a wavelet decomposing algorithm.

9. The image processing method according to claim 1, wherein the low frequency components of the visible image and/or the high frequency components of the infrared image are filtered by using a bilateral filter algorithm, so as to generate the base image layer and/or the detail image layer.

10. An image processing apparatus, comprising:
an image acquiring unit, configured to acquire a visible image and an infrared image of a captured object;
a visible image decomposing unit, configured to decompose the visible image to generate a base image layer containing low frequency components;
an infrared image decomposing unit, configured to decompose the infrared image to generate a detail image layer containing high frequency components; and
an image combining unit, configured to combine the base image layer and the detail image layer, so as to generate a combined image of the captured object.

11. The image processing apparatus according to claim 10, wherein the visible image decomposing unit comprises:
a visible image transforming unit, configured to transform the visible image into a color image of a YCbCr space;
a visible image extracting unit, configured to extract a luminance channel image and a chrominance channel image of the color image of the YCbCr space; and
a luminance channel image decomposing unit, configured to decompose the luminance channel image to generate the base image layer.

12. The image processing apparatus according to claim 10, wherein the image processing apparatus further comprises:
a color adding unit, configured to combine the combined image and the chrominance channel image to generate a color combined image; and
an image restoring unit, configured to transfer the color combined image to an RGB space.

13. An electronic device, comprising the image processing apparatus as claimed in claim 10.

14. The image processing apparatus according to claim 11, wherein the image processing apparatus further comprises:
a color adding unit, configured to combine the combined image and the chrominance channel image to generate a color combined image; and
an image restoring unit, configured to transfer the color combined image to an RGB space.

15. The image processing method according to claim 2, wherein the method further comprises:
combining the combined image and the chrominance channel image to generate a color combined image; and
transferring the color combined image into an RGB space.

16. The image processing method according to claim 3, wherein the low frequency components reflect basic image information of the captured object, and the high frequency components reflect characteristic image information of the captured object.

17. The image processing method according to claim 7, wherein the low frequency components of the visible image and/or the high frequency components of the infrared image are determined by using a wavelet decomposing algorithm.

18. The image processing method according to claim 2, wherein the low frequency components of the visible image and/or the high frequency components of the infrared image are filtered by using a bilateral filter algorithm, so as to generate the base image layer and/or the detail image layer.

19. The image processing method according to claim 8, wherein the low frequency components of the visible image and/or the high frequency components of the infrared image are filtered by using a bilateral filter algorithm, so as to generate the base image layer and/or the detail image layer.
